(19) United States
(12) Patent Application Publication
(10) Pub. No.: US 2012/0260608 A1
(43) Pub. Date: Oct. 18, 2012

(54) DRAIN CONNECTOR FOR SUBSTANCE PROCESSING RECEPTACLE

(75) Inventors: Vishwas Pethe, Shakopee, MN (US); Matthew Kusz, Bloomington, MN (US)

(73) Assignee: ATMI PACKAGING, INC., Danbury, CT (US)

(21) Appl. No.: 13/509,219

(22) PCT Filed: Nov. 9, 2010
(86) PCT No.: PCT/US10/55928

§ 371 Date: Jun. 26, 2012

(30) Foreign Application Priority Data
Nov. 10, 2009 (US) 12/615681

(51) Int. Cl. B65B 55/12; B23P 11/00

(52) U.S. Cl. 53/428; 137/15.01

(57) ABSTRACT

A drain connector arranged for mounting to a tank or bag having an interior volume includes a drain flange defining a bore having an inner diameter, and a hollow body having at least an upper portion with a maximum outer diameter that is no greater than the inner diameter of the bore and arranged to convey fluid to the interior volume, with at least one circumferential sealing element between the drain flange and hollow body, with the drain flange including a body extending outside the interior volume and including at least one retaining element arranged to retain the hollow body in a position. A drain flange may include multiple bores for receiving multiple hollow bodies, with each hollow body including at least one circumferential sealing element. One or more drain flanges may be generic for use with hollow bodies of different characteristics to enable fabrication of a processing container or bag by affixing one or more drain flanges, and then selecting among the plurality of different hollow bodies for insertion into the drain flange(s).

### CROSS-REFERENCE TO RELATED APPLICATION

This application claims priority to U.S. patent application Ser. No. 12/615,681 filed on Nov. 10, 2009 and published as U.S. Patent Application Publication No. 2007/0102450A1. The disclosures of the foregoing application and publication are hereby incorporated by reference herein, for all purposes.

### FIELD OF THE INVENTION

The present invention relates to substance processing receptacles and drain connectors therefor, including receptacles used for the processing (e.g., mixing and/or reacting) of various substances in laboratory and industrial settings.

### BACKGROUND

Mixing and/or reacting of components, such as different types of solids, liquids and/or gases, has numerous applications in different industries. For example, in the pharmaceutical industry, different types of drug precursor materials and/or therapeutic agents are mixed and/or reacted. In the medical field, components such as body fluids and/or drugs are mixed and/or reacted. In the semiconductor field, wet solutions are combined with abrasives to make slurries. The food industry also incorporates mixing operations into a number of applications, including the mixing of water with dried food to accomplish rehydration.

In these and other industries, however, the components to be mixed or reacted may be hazardous, dangerous, infectious and/or require high levels of purity. For example, in the pharmaceutical and/or medical industries, components subject to mixing or reacting operations may be toxic. In the medical field, fluids to be processed may contain live viruses (e.g., HIV) or other pathogens, justifying the need for individuals to avoid contact with such fluids. Furthermore, in the semiconductor industry, handling of chemicals is avoided to reduce the potential for forming particulates and introducing impurities. For these reasons, it is desirable to accomplish mixing or reacting steps in sealed substance processing assemblies fabricated with non-reactive materials.

In substance processing assemblies, it is important to minimize dead volumes (stagnant regions where unmixed components can avoid agitation) for a number of reasons. A first reason to minimize dead volume is to promote thorough or high quality mixing, which is critical to certain applications such as pharmaceutical formulation. Another reason to avoid dead volumes is to reduce the potential for sedimentation of solids. Dead volumes located in or near drain connectors are particularly problematic, since they can lead to undesirable contamination or carryover between processing batches, or if solids are involved then sedimentation can cause clogs or other draining problems that detrimentally affect system reliability.

Conventional systems for mixing and/or reacting substances utilize reusable tanks fabricated from materials such as glass or stainless steel, and associated agitation means. Prior to use, these tanks typically must be washed and sterilized. An autoclave may be used for washing and sterilizing small volume tanks, while a water steam-based operation may be employed for washing and sterilizing larger volume tanks. When preparing batches of post-etch residue removers for semiconductor applications, introduction of contaminants must be excluded at all levels of processing to decrease particulate formation, which leads to failure of finished semiconductor devices. These washing, sterilizing, and processing operations are often time-consuming and expensive, and require highly qualified individuals for their performance.

Drain connectors used with conventional mixing systems are reusable, and typically include a drain tube leading from the tank to a valve or other sealing means. The drain tube represents a dead volume that can inhibit complete mixing and/or permit sedimentation of solids. The above-mentioned washing, sterilizing, and processing operations may be performed with a drain connector in place, but without certainty that the drain connector is absolutely free of contaminants. Alternatively, the drain connector may be disassembled and separately cleaned or sterilized between mixing batches, but at the expense of substantial effort and delay.

In manufacture and/or use of processing containers or processing bags, it may be challenging to adapt a processing container or processing bag to an existing system of fluid conduits. It would be desirable to provide flexibility in configuring inlets and/or outlets of a processing container or processing bag different functions while minimizing the number of fluid connections and adapters, such as to provide valve utility, or to provide unvalved supply or drain utility.

In consequence, the art continues to seek improvement in mixing assemblies and their associated drain connectors. It would be desirable to provide a low dead volume drain connector for a mixing assembly. It would be desirable for a drain connector to be suitable for fitment to various different types of mixing assemblies. It would be desirable to be able to determine the presence or monitor characteristics of substances within a drain connector. It would also be desirable for the drain connector to be sufficiently simple and inexpensive to make it cost-effective to be disposed after a single use if desired so as to avoid contamination or carryover problems. It would also be desirable for a drain connector to be sterilizable together with an associated mixing assembly.

### SUMMARY

Various embodiments of the present invention include drain connectors arranged for mounting to processing containers or bags, and processing containers or bags including same.

In one aspect of the invention, a drain connector is arranged for mounting to a tank or bag having an interior volume, the drain connector comprising: a drain flange defining a bore having an inner diameter, the drain flange having a radially extending flange lip adapted for mounting to a wall of said tank or bag; a hollow body having at least an upper portion with a maximum outer diameter that is no larger than the inner diameter of the bore, and being arranged to convey fluid to or from the interior volume; and at least one circumferential sealing element disposed between the drain flange and the hollow body; wherein the drain flange includes a flange body portion extending outside the interior volume and terminating at a lower edge, the flange body portion comprising at least one retaining element between the radially extending flange lip and the lower edge.

Another aspect of the invention relates to a method of fabricating a processing container or processing bag defining an interior volume, the method comprising: mounting at least one drain flange to at least one wall of the processing container or processing bag, the at least one drain flange comprising a radially extending flange lip and defining a bore having an inner diameter; selecting at least one hollow body from a plurality of hollow bodies compatible with the at least one drain flange, the at least one hollow body having at least one end with a maximum outer diameter that is no larger than the inner diameter of the bore, and being arranged to convey fluid to or from the interior volume, wherein the plurality of hollow bodies comprises hollow bodies that differ with respect to at least one of core size, connection type, connection size, hollow body material type, circumferential sealing material type, and presence or absence of an end opening; and inserting the selected at least one hollow body into the bore of the at least one drain flange.

Another aspect of the invention relates to a drain connector arranged for mounting to a tank or bag having an interior volume, the drain connector comprising: a drain flange defining a plurality of bores, the drain flange having a radially extending flange lip adapted for mounting to a wall of said tank or bag; a plurality of hollow bodies arranged for insertion into the plurality of bores, and being arranged to convey fluid to or from the interior volume; and for each hollow body of the plurality of hollow bodies, at least one circumferential sealing element disposed between the drain flange and the hollow body.

In another aspect of the invention, any of the foregoing aspects may be combined for additional advantage. Moreover, any one ore more aspects as described herein may be combined with any one or more other features or aspects as described herein. Other aspects, features and embodiments of the invention will be more fully apparent from the ensuing disclosure and appended claims.

### BRIEF DESCRIPTION OF THE DRAWINGS

In the drawings, like numbers are intended to refer to like elements or structures. None of the drawings are drawn to scale unless indicated otherwise.

FIG. 1 is an exploded elevation view of a hollow plunger and drain flange of a drain connector according to a first embodiment of the present invention, with interior voids within the plunger and drain represented in shadowed lines.

FIG. 2A shows the drain connector of FIG. 1 in a closed state, with the plunger illustrated in elevation view, and with the drain flange and circumferential sealing O-rings illustrated in cross-sectional view.

FIG. 2B illustrates the same views as FIG. 2A, but with the drain connector in an open state.

FIG. 3A is a bottom view of the drain flange shown in FIG. 1 and FIG. 2A-2B.

FIG. 3B is a top view of the drain flange of FIG. 3A.

FIG. 4A is an elevation view of the plunger of FIG. 1 and FIGS. 2A-2B.

FIG. 4B is a bottom view of the plunger of FIG. 4A.

FIG. 4C is a top view of the plunger of FIGS. 4A-4B.

FIG. 5A is an elevation view of a hollow plunger of a drain connector according to a second embodiment of the present invention.

FIG. 5B is a cross-sectional view of a portion of the plunger of FIG. 5A taken along section lines “A”-“A” illustrated in FIG. 5A, the plunger including a lower travel stop element.

FIG. 5C is an elevation view of the travel stop element of FIG. 5B, with the interior voids within the travel stop represented in shadowed lines.

FIG. 6A shows the plunger of FIGS. 2A-2B proximate to a separate outlet tube, with the plunger shown in elevation view and with the outlet tube and two circumferential sealing O-rings shown in cross-sectional view.

FIG. 6B illustrates the same views as FIG. 6B, but with the outlet tube joined to the plunger.

FIG. 7A provides a cross-sectional view of the drain flange of FIGS. 2A-2B removably joined to a processing tank to form a portion of a processing receptacle according to another embodiment of the present invention.

FIG. 7B provides a cross-sectional view of a drain flange similar to the flange shown in FIGS. 2A-2B permanently joined to a processing bag to form a portion of a processing receptacle according to another embodiment of the present invention.

FIG. 7C provides a cross-sectional view of the drain flange of FIGS. 2A-2B joined to a processing bag, with the bag removably fitted into a processing tank, to form a portion of a processing receptacle according to another embodiment of the present invention.

FIG. 7D provides a cross-sectional view of the drain flange similar to the flange shown in FIGS. 2A-2B non-permanently joined to a processing bag, with the bag removably fitted into a processing tank, to form a portion of a processing receptacle according to another embodiment of the present invention.

FIG. 8 is a perspective view of a processing tank or bag for use with a drain connector according to the present invention, the tank or bag having a hollow sleeve containing a mixing element and a connecting rod, with features interior to the tank or bag represented in shadowed lines.

FIG. 9 is a perspective view of a processing tank or bag with three drain connectors according to the present invention and with a hollow sleeve containing a mixing element and a connecting rod, with features internal to the various external structures represented in shadowed lines.

FIG. 10A is an elevation view of a hollow plunger and drain flange of a drain connector in a closed state according to another embodiment of the present invention, with interior voids within the plunger and drain represented in shadowed lines.

FIG. 10B illustrates the same view as FIG. 10A, but with the drain connector in an open state.

FIG. 11A is a side elevation view of a drain flange according a further embodiment of the present invention, the drain flange including multiple retaining elements arranged along an annular portion thereof, with the drain flange being matable with either a plunger (such as illustrated in FIG. 11B) or a port (such as illustrated in FIG. 12).

FIG. 11B is a side elevation view of a hollow plunger suitable for use with the drain flange of FIG. 11A.

FIG. 11C is a side elevation view of a drain connector assembly including the hollow plunger of FIG. 11B mated with the drain flange of FIG. 11A, with the hollow plunger positioned in a closed state relative to the drain flange.

FIG. 11D is a perspective cross-sectional view of the drain connector assembly of FIG. 11C, with the hollow plunger positioned in a closed state relative to the drain flange.

FIG. 11E is a perspective cross-sectional view of the drain connector assembly of FIGS. 11C-11D, with the hollow plunger positioned in an open state relative to the drain flange.

FIG. 12A is a perspective cross-sectional view of a hollow port that is matable with the drain flange of FIG. 11A.

FIG. 12B is a perspective cross-sectional view of a drain connector assembly including the hollow port of FIG. 12A mated with the drain flange of FIG. 11A.

### DETAILED DESCRIPTION

The disclosures of the following patents/applications are hereby incorporated by reference as if set forth herein: U.S. Pat. No. 6,749,808 entitled “Sterilizable container with a sterilizable adapter for docking to a port of an isolation system;” U.S. Pat. No. 7,249,880 entitled “Flexible mixing bag for mixing solids, liquids and gases;” and U.S. Pat. No. 7,083,323 entitled “Flexible mixing bag for mixing solids, liquids and gases,” each of which are commonly assigned to the assignee of the present application.

Various shortcomings associated with processing receptacles employing conventional drain connectors are overcome by embodiments of the present invention. For example, dead volumes may be reduced by positioning a closeable drain connector proximate to the drain receptacle, thus avoiding the use of a remotely located valve separated from the receptacle by a drain tube.

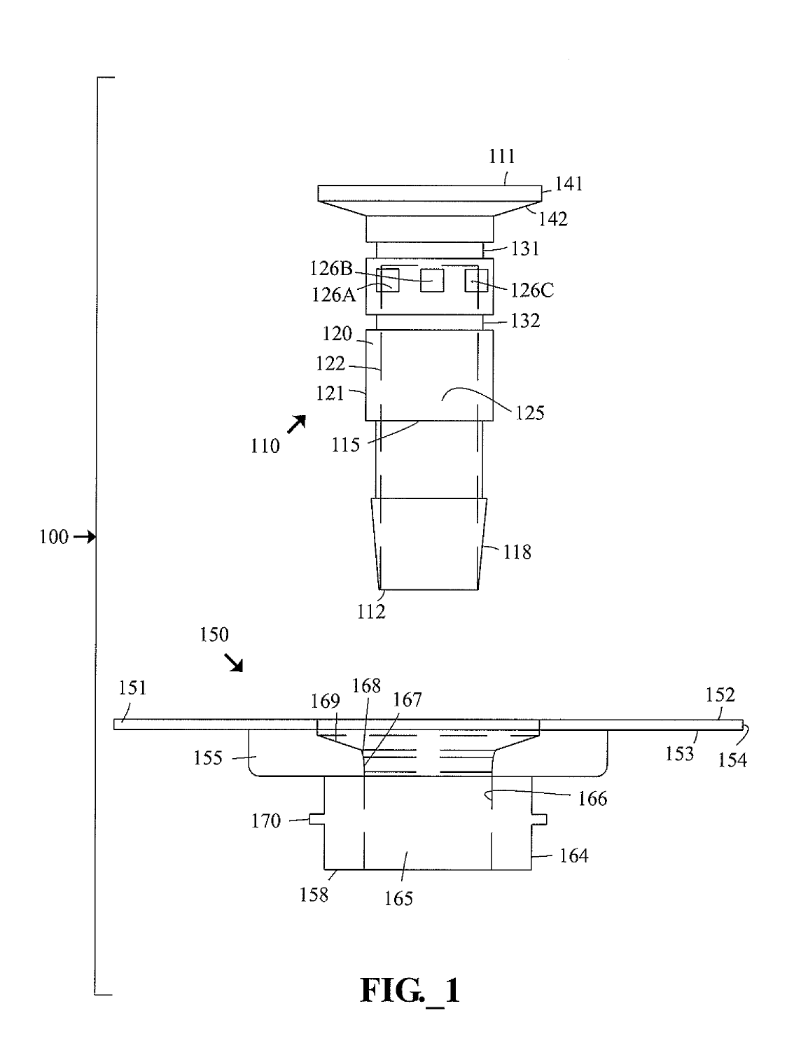

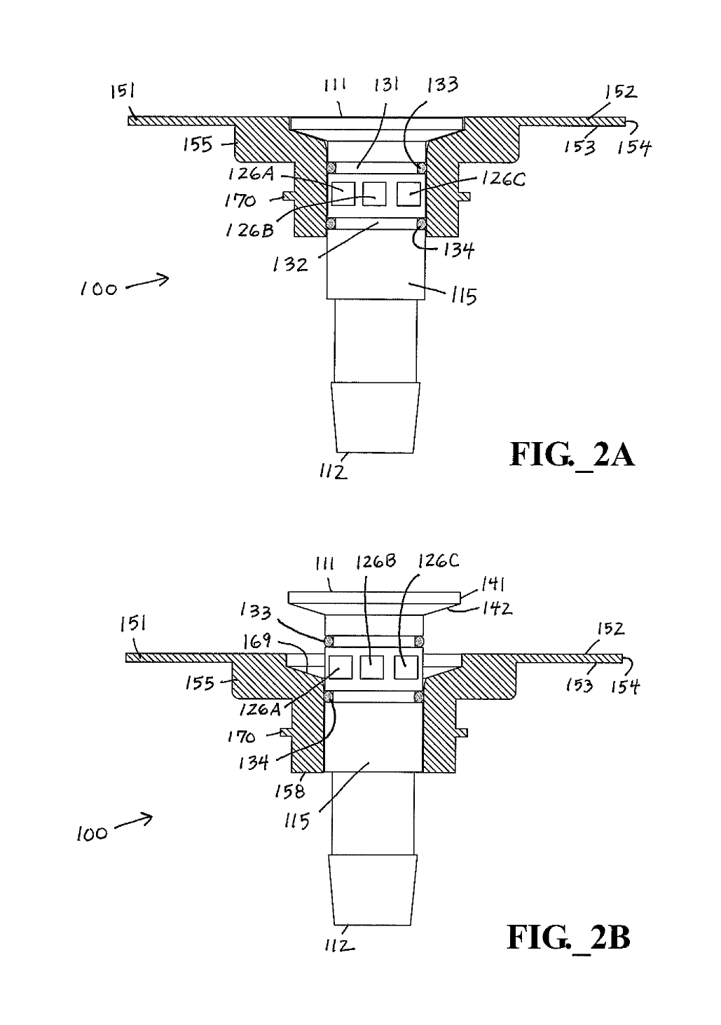

Components of a drain connector 100 according to a first embodiment of the present invention are shown in FIGS. 1, 2A-2B, 3A-3B and 4A-4C, with the drain connector 100 showed in two states of operation in FIGS. 2A-2B.

FIG. 1 is an exploded elevation view of a hollow plunger and drain flange of a drain connection according to a first embodiment of the invention. The drain connector 100 includes a hollow plunger 110 that is moveable relative to and within a drain flange 150. The plunger 100 has a body 115 (which may be tubular in shape), a first closed end 111, and a second open end 112, and a wall 120 with an exterior surface 121 and an interior surface 122 defining a hollow core 125 leading or open to the open end 112. Multiple passages 126A-126C are defined through the wall 120 and extend from the exterior surface 121 into the hollow core 125. The exterior surface 121 of the wall 120 further defines two circumferential recesses 131, 132 adjacent to the passages 126A-126C. Specifically, the passages 126A-126C are disposed between the recesses 131, 132, with the recesses 131, 132 being sized to retain O-rings 133, 134, respectively, to provide sealing utility between the plunger 110 and an inner surface 166 of the flange 150.

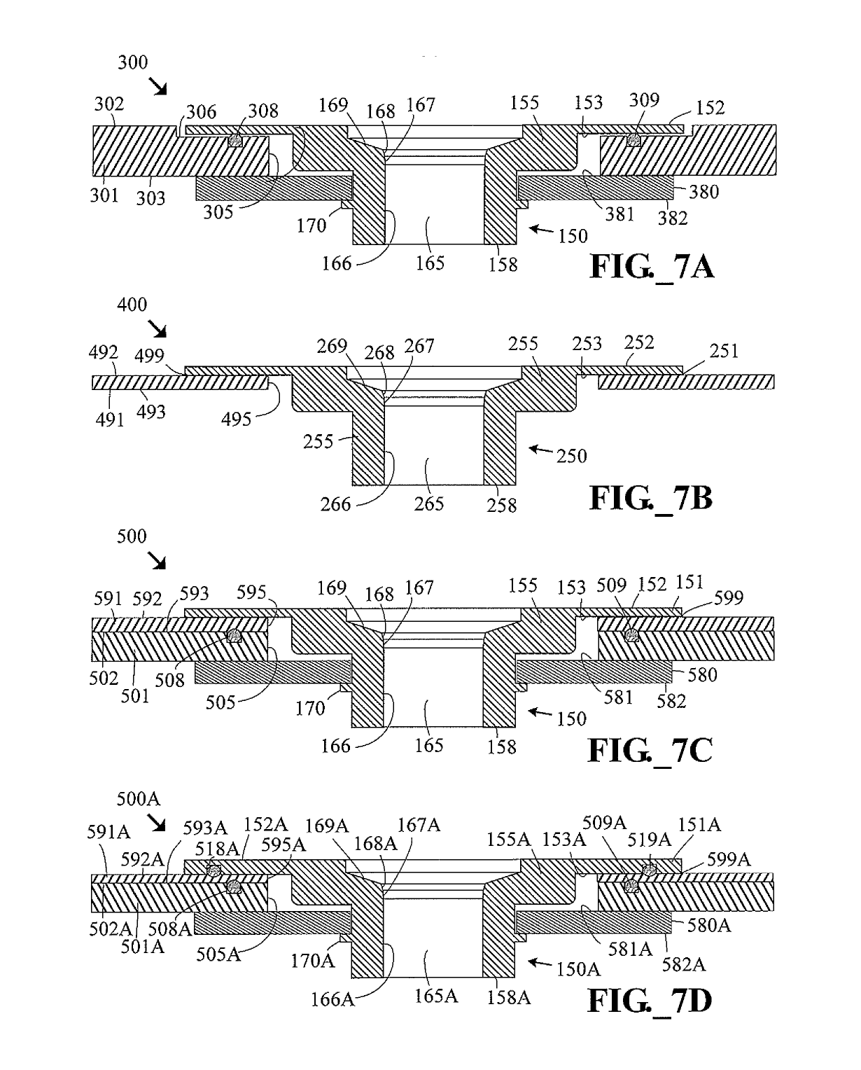

Continuing to refer to FIG. 1, the first closed end 111 of the plunger 110 includes a flared portion 141 that serves as a travel stop for the plunger 110 when it moves (e.g., downward) into the aperture 165 of the flange 150. The flared portion or travel stop 141 includes an outer tapered surface 142 sized and shaped to mate against a corresponding inner tapered surface 169 of the flange 150. At the opposite end of the plunger 110, the body 115 preferably includes a tapered neck portion 118 intended to mate with an outlet tube (such as the tube 50 illustrated in FIGS. 6A-6B).

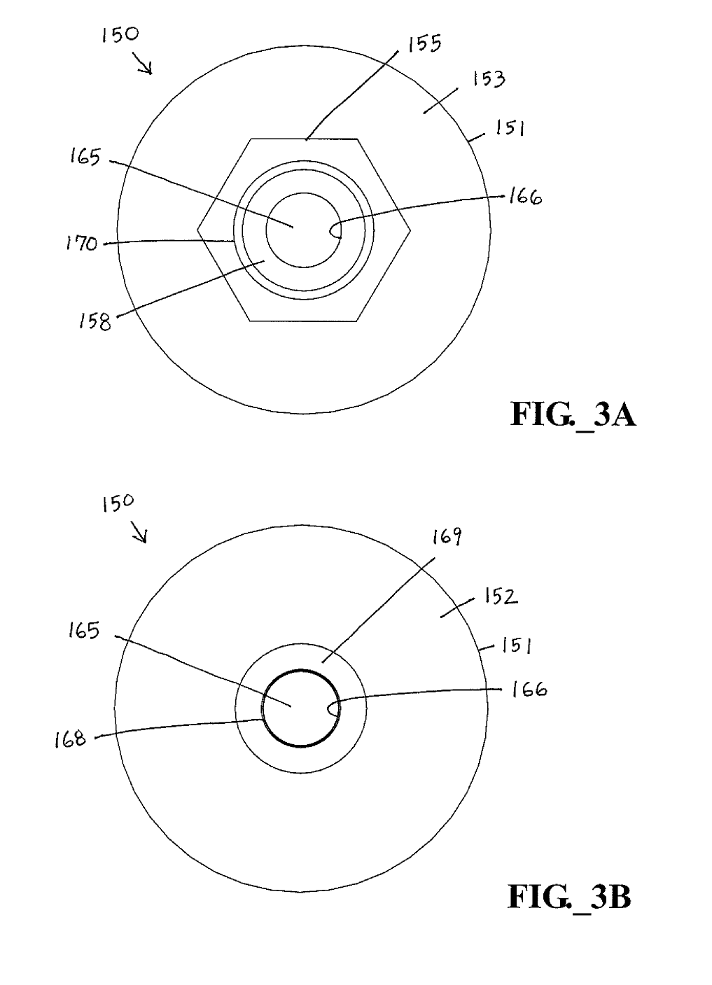

Continuing to refer to FIG. 1, the flange 150 includes a flange lip 151 having an upper surface 152, a lower surface 153, and a peripheral edge 154. The flange lip 151 extends outward from the flange body 155, which is preferably hexagonal in shape, as shown in FIG. 3A. The flange body 155 defines an aperture 165 bounded by an inner surface 166 and tapered upper surface portions 167-169, as shown in FIG. 3B. The lower portion of the inner surface 166 preferably has substantially constant interior dimensions to permit the plunger 110 to slide freely therein, with the O-rings 133, 134 contacting the inner surface 166. The flange body 155 includes an outer surface 164 with a retaining element (e.g., retaining lip) 170 protruding therefrom. The flange body 155 further includes a lower body surface 158 that is preferably annular in shape surrounding the aperture 165.

FIG. 2A shows the drain connector of FIG. 1 in a closed state, with the plunger illustrated in elevation view, and with the drain flange and circumferential sealing O-rings illustrated in cross-sectional view. FIG. 2B illustrates the same views as FIG. 2A, but with the drain connector in an open state—i.e., with the plunger 110 elevated relative to the drain flange 150 to open a fluid pathway through the passages 126A-126C into the hollow core 125.

FIG. 3A is a bottom view of the drain flange 150 shown in FIGS. 1 and 2A-2B, illustrating the flange lip 151, lower surface 153, flange body 155, lower body surface 158, aperture 165, inner surface 166, and retaining lip 170 all as described previously.

FIG. 3B is a top view of the drain flange 150 shown in FIGS. 1, 2A-2B, and 3A, illustrating the flange lip 151, the upper surface 152, the aperture 165, the inner surface 166, and the upper surface portion 168, all as described previously.

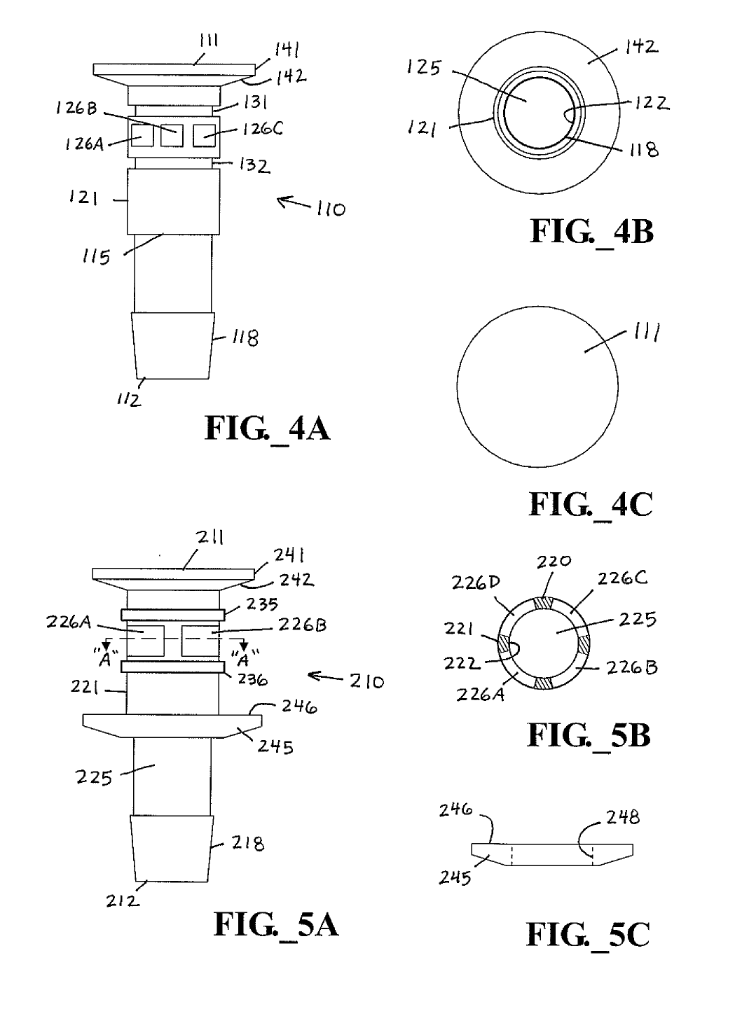

FIG. 4A is an elevation view of the plunger of FIG. 1 and FIGS. 2A-2B, illustrating the first closed end 111, the second open end 112, the exterior surface 121, the body 115, the tapered neck portion 118, the flared portion 141, the outer tapered surface 142, the O-ring recesses 131, 132, and the passages 126A-126C, all as described previously.

FIG. 4B is a bottom view of the plunger of FIG. 4A, illustrating the exterior surface 121, the interior surface 122, the hollow core 125, the tapered neck portion 118, and the outer tapered surface 142, all as described previously. FIG. 4C is a top view of the plunger of FIGS. 4A-4B, illustrating the first closed end 111.

While various materials and construction methods may be used to fabricate the plunger 110 and flange 150, preferred embodiments employ polymeric materials and are molded (e.g., injection-molded). Polyethylene materials including low- and high-density polyethylene are particularly preferred materials for fabricating the plunger 110 and flange 150. Substantially optically transmissive or transparent materials may desirably be used to form the plunger 110 and the flange 150 to permit the contents of the drain connector 100 to be viewed or inspected. Benefits of utilizing such materials include low fabrication cost, compatibility (e.g., non-reactivity) with a wide variety of substances used in industrial and laboratory settings, and amenability to being sterilized where required for certain applications. Low fabrication cost renders drain connectors as disclosed herein suitable for single- or disposable-use operation, thus eliminating costly cleaning/sterilizing operations and eliminating the possibility of carryover between batches. Each of the plunger 110 and the flange 150 preferably comprises a single piece, but may alternatively be constructed from multiple pieces if desired.

One or more sensors of various types may be incorporated into the flange and/or plunger to monitor at least one characteristic of a substance contained or flowing within the drain connector. Temperature, pH, conductivity, and pressure are examples of desirable characteristics of substances to be sensed or monitored with appropriate sensors.

While various embodiments disclosed herein illustrate plungers having perimeters that are substantially circular in shape, and likewise drain flange apertures that are substantially circular in shape, it is to be understood that such embodiments are intended to be illustrative only and the invention is not limited to particular shapes. Plungers and flanges having circular or oval shapes are preferred, but other shapes may be used.

While multiple passages 126A-126C are shown as being defined through the wall 120, a plunger 110 may only require a single passage. If desired, a multiplicity of passages 126A-126C may be defined through the wall 120 of any size suitable for an intended application. In one embodiment, the passages 126A-126C may be sized to provide straining or filtration utility. In another embodiment, the passages may be sized to permit air or other gases to be introduced from the plunger 110 into a suitable receptacle, such as to supply oxygen to biological moieties contained therein or to furnish gaseous reactants for a desired reaction. In this vein, the adjective “drain” as applied to the term “drain connector” herein is intended to refer to the ability of such a device to modulate flow, but without being limited to modulating flow in only one direction.

Two states of operation of the drain connector 100 are shown in FIGS. 2A-2B, with FIG. 2A showing the drain connector 100 in a closed state and FIG. 2B showing the drain connector 100 in an open state. When the drain connector 100 is in a closed state, the upper surface 111 of the first closed end is preferably substantially flush with the upper surface 152 of the drain flange 150. This minimizes any interference between the drain connector 100 and a mixing element or other agitation means disposed within a processing receptacle to which the drain connector 100 may be attached. When the drain connector 100 is in a closed state, the outer tapered surface 142 of the plunger 110 is mated against the corresponding inner tapered surface 169 of the flange, and both the first (upper) O-ring 133 and second (lower) O-ring 134 are sealingly engaged against the inner surface 166 of the drain flange 150. Such sealing engagement prevents the passage of any solids, liquids, or gases through the drain connector 100. Upward movement of the plunger 110 eliminates sealing engagement between the first (upper) O-ring 133 and the inner surface 166, thus exposing the passages 126A-126C and placing the drain connector 100 in an open state. Thus, substances located within a processing receptacle to which the drain connector 100 is attached may flow through the passages 126A-126C into the hollow core 125 and exit the receptacle (not shown). By providing a close fit between the upper portion of the plunger 110 and the flange 150, and by positioning both the upper and lower O-rings 133, 134 proximate to the passages 126-126C, dead volume in the drain connector is minimized.

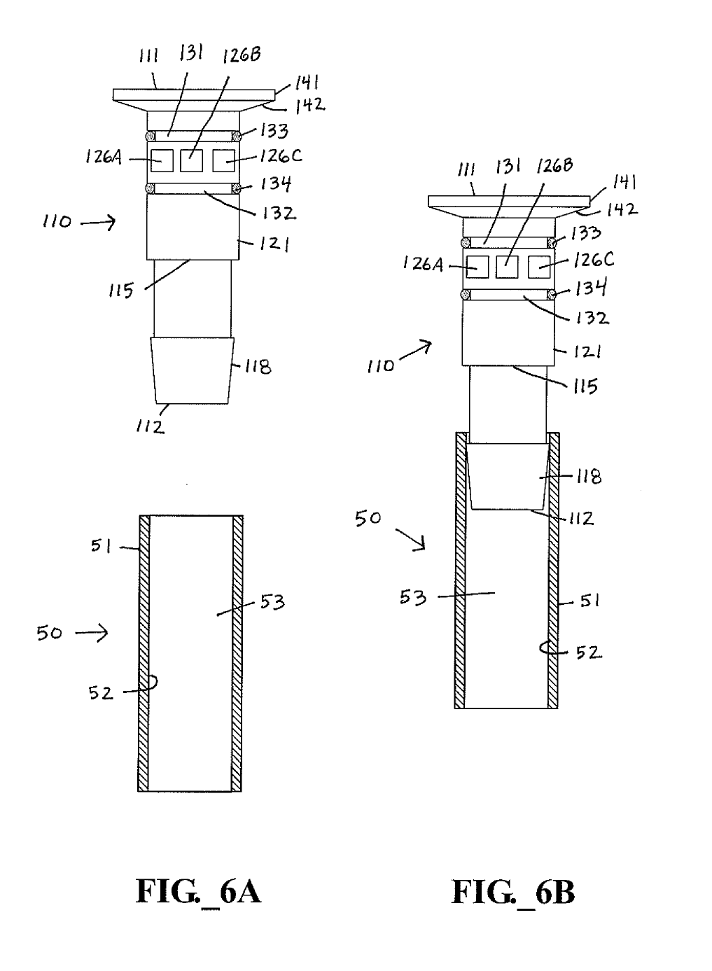

An alternative hollow plunger 210 according to a second embodiment is shown in FIGS. 5A-5C. The plunger 210 has a body 215, a first closed end 211, a second open end 212, and a wall 220 with an exterior surface 221 and an interior surface 222 defining a hollow core 225 leading or open to the open end 212. Multiple passages 226A-226D are defined through the wall 220 and extend into the hollow core 225. As an alternative to recesses and O-rings, this plunger 210 includes protruding sealing rings 235, 236, with one ring 235 disposed above the passages 226A-226D and the other ring 236 disposed below the passages 226A-226D. In addition to having a flared portion 141 with surface 142 serving as a first travel stop, the plunger 210 further includes a second travel stop 245 that limits the outward or upward movement of the plunger 210 relative to an associated drain flange. The upper surface 246 of the second travel stop 245 is intended to contact the lower body surface 158 of the drain flange 150 shown in the preceding figures. The travel stop 245 may be integrally formed to the plunger 210, or, as shown in FIG. 5C, it may be formed as a separate element having an interior cavity 248 for mating with the exterior surface 221 of the plunger 210.

The joining of a plunger 110 with an outlet tube 50 is shown in FIGS. 6A-6B. An outlet tube having an outer wall 51 and an inner wall 52 defining a bore 53 may be fitted to the plunger 110 by inserting the tapered neck 118 into the tube 50. Various types of outlet tubes may be used, with silicone tubing being one preferred type. Sealing between the outlet tube 50 and the plunger 110 may be further assured with adhesive, or more preferably, with an external clamp or strap (not shown). The outlet tube 50 functions to conduct substances from (or alternatively, to) the hollow core 125 of the plunger 110. If desired, the outlet tube 50 may also be used to actuate the drain connector 100. With the outlet tube 50 joined to the neck 118 of the plunger 110, upward movement of the outlet tube 50 pushes the drain connector 110 into the open position as illustrated in FIG. 2B, while downward movement of the outlet tube 50 draws the drain connector into the closed position as illustrated in FIG. 2A. Alternatively, conventional actuating elements such as levers, rods, solenoids, or other actuators may be used to cause the drain connector 100 to cycle between the open and closed positions.

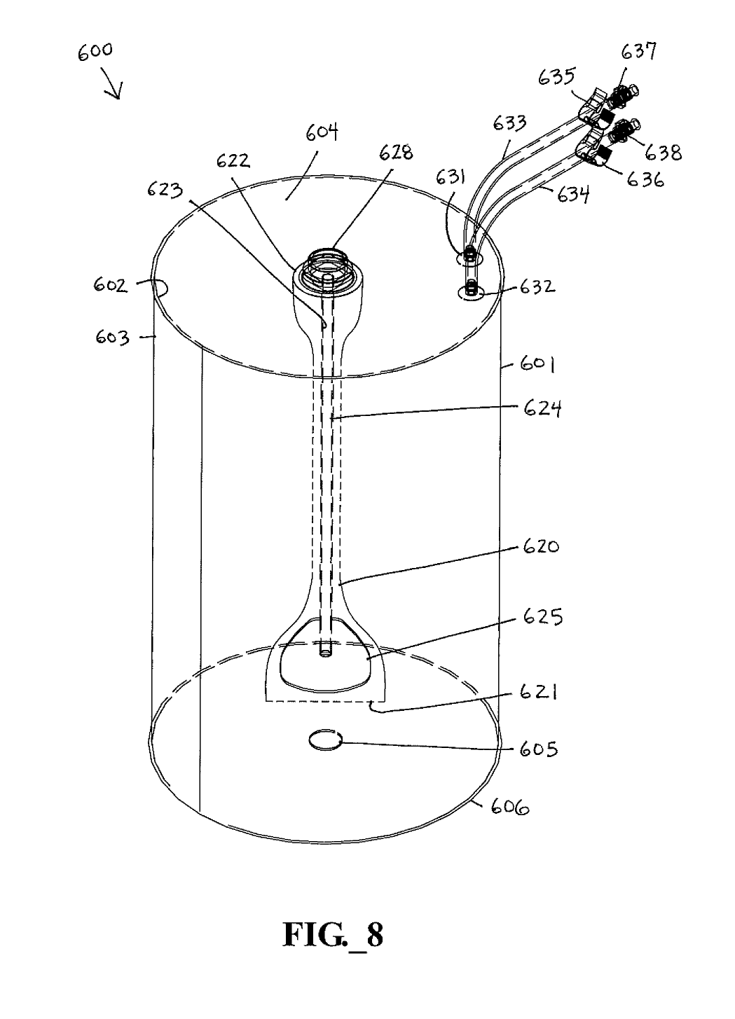

In further embodiments, various types of fluid processing receptacles include drain connectors as provided herein in conjunction with processing tanks and/or bags. FIG. 7A illustrates a portion of a first fluid receptacle 300 including a processing tank 301 (with only a lower portion of the tank 301 being illustrated). The tank 301 has an inner surface 302, an outer surface 303, and defines an aperture 305 for receiving a drain flange 150. (While not illustrated in FIG. 7A to promote clarity, it is to be understood that a hollow plunger 110 or 210 as disclosed herein would be provided in conjunction with the drain flange 150 to form a drain connector 100). The tank 301 further defines a shallow recess 306 for accepting the flange lip 152, and a narrower but deeper recess 308 for holding an O-ring 309 to promote sealing between the flange 150 and the tank 301. Compressive contact between the flange 150 and the tank 301 is maintained by way of a retaining element 380 engaging the retaining lip 170 protruding from the flange body 155. Specifically, the lower surface 382 of the retaining element 380 engages the retaining lip 170, while the upper surface 383 of the retaining element 380 engages the lower surface 303 of the tank 301, thus exerting a downward force on the flange 150 that compresses the flange lip 152 against the O-ring 309. Removal of the retaining element 382 permits the flange 150 to be separated from the tank 301 if desired. The use of such a retaining element 382 permits the drain connector 100 to be used with and easily installed in a wide variety of different types of processing tanks.

In another embodiment, a drain connector may be joined to a processing bag fabricated of substantially non-rigid materials to form a processing receptacle. FIG. 7B illustrates a receptacle 400 having a drain connector including a drain flange 250 permanently joined to a non-rigid processing bag 491. The bag 491, which has an inner surface 492 and an outer surface 491 and defines an aperture 495 for receiving the drain connector, is preferably constructed with a polymeric film such as high-density or low-density polyethylene. The drain flange 250 is substantially similar to the drain flange 150 disclosed previously herein, but with the omission of any retaining lip. The drain flange 250 includes a flange lip 251 having an upper surface 252 and a lower surface 253, and a flange body 255 defining an aperture 265 bounded by an inner surface 266 and tapered surface portions 267-269. A lower body surface 258 provides the lower boundary of the flange 250 and surrounds the aperture 265. The flange 250 may be joined to the bag 491 along by any appropriate means, such as ultrasonic welding, solvent welding, thermal bonding, and adhesive bonding. The interface between the inner surface 492 of the bag 491 and the lower surface 253 of the flange lip 251 forms a joint 499. One advantage of joining the drain connector/drain flange 250 to the processing bag 491 to form a processing receptacle is that the receptacle can be sterilized as a combined assembly, and then packaged together following sterilization in a sealed package. This ensures sterile conditions are maintained during transport and minimizes the chance of contamination when the receptacle is readied for first use. The receptacle is particularly well-suited for disposable operation. If desired, the bag may be structurally supported within a rigid tank or a substantially open frame with appropriate hooks or other fasteners (not shown).

A processing receptacle according to another embodiment including a processing tank, a processing bag, and a drain connector is illustrated in FIG. 7C. The receptacle 500 includes a processing bag 591 having a drain flange 150 joined thereto, with the bag 591 being supported by a tank 501 that also provides secondary containment utility in case the bag 591 should rupture. In one embodiment, the bag 591 is permanently joined to the drain flange 150, such as by ultrasonic welding. In another embodiment, the bag 591 is compressed between the drain flange 150 and the tank 501 without being permanently joined thereto, so as to permit the drain flange 150 to be re-used with different disposable bag 591. An aperture 505, 595 is defined in each of the tank 501 and bag 591 to receive the flange 150. The bag 591 has an outer surface 593 and an inner surface 592 joined to the lower surface 153 of the flange lip 151 to form a joint 599. The lower surface 593 of the bag 591 is disposed against the inner surface 502 of the tank 501, with the tank 501 further defining a recess 508 containing an O-ring 509 to promote sealing between the tank 501 and the bag 591. Compression of the bag 591 against the tank 501 is maintained by the retaining element 580, which engages the retaining lip 170 protruding from the flange body 155. Such compression may be used in conjunction with the O-ring 509 to maintain sealing engagement between the drain flange 150 and the bag 591. Specifically, the lower surface 582 of the retaining element 580 engages the retaining lip 170, while the upper surface 583 of the retaining element 580 engages the lower surface 503 of the tank 501, thus exerting a downward force on the flange 150 that compresses the flange lip 152 and the lower surface 593 of the bag 591 against the O-ring 509. In this manner, a disposable processing bag 591 with the associated drain connector/drain flange 150 may be used with a rigid mixing tank 501 such that the mixing tank need not be re-used or re-sterilized between batches.

A processing receptacle according to another embodiment including a processing tank, a processing bag, and a drain connector is illustrated in FIG. 7D. The receptacle 500A closely resembles the receptacle 500 illustrated in FIG. 7C, with the addition of a second O-ring 519A between the drain flange 150A and the bag 591A, with a slightly thicker drain flange 150A to accommodate such O-ring 519A, and with a slightly thinner bag 591A. In the present embodiment, the bag 591A is not permanently joined to the drain flange 150A. The bag 591A is supported by a tank 501A providing secondary containment utility. An aperture 505A, 595A is defined in each of the tank 501A and the bag 591A to receive the drain flange 151A. The bag 591A has an outer surface 593A and an inner surface 592A joined to the lower surface 153A of the flange lip 151A to form a joint 599A. The lower surface 153A of the drain flange 150A further defines a recess 518A for receiving an O-ring 519A adapted to provide a seal between the drain flange 591A and the bag 591A. The lower surface 593A of the bag 591A is disposed against the inner surface 502A of the tank 501A, with the tank 501A further defining a recess 508A containing another O-ring 509 to promote sealing between the tank 501A and the bag 591A. Compression of the bag 591A against the tank 501A is maintained by the retaining element 580, which engages the retaining lip 170A protruding from the flange body 155A. Such compression may be used in conjunction with both O-rings 509A, 519A to maintain sealing engagement between the tank 501A and the bag 591A, and between the bag 591A and the drain flange 150A. Specifically, the lower surface 582A of the retaining element 580A engages the retaining lip 170A, while the upper surface 583A of the retaining element 580A engages the lower surface 503A of the tank 501A, thus exerting a downward force on the flange 150A that compresses both O-rings 509A, 519A against the respective surfaces 591A, 593A of the bag 591. In this manner, a disposable processing bag 591A with the associated drain connector/drain flange 150 may be used with a rigid mixing tank 501 such that the mixing tank need not be re-used or re-sterilized between batches. The drain flange 591A may be re-sterilized and re-used with another mixing bag/mixing tank assembly if desired.

As an alternative to using a drain connector having a plunger with circumferential seals to mate with an inner surface of a drain flange, the inner surface of the drain connector may include raised sealing elements. In such an embodiment, a selectively closeable drain connector includes a moveable hollow plunger with a plunger body having a first closed end, a second open end, and a wall with an exterior surface and with an interior surface bounding a hollow core. The plunger body defines at least one passage extending from the exterior surface into the hollow core. The drain flange defines an aperture bounded by an inner surface and adapted to receive the plunger, with the inner surface having a first and a second raised sealing element. When the drain connector is in a closed state, the at least one passage is disposed between the first and the second raised sealing element, and each of the first and the second raised sealing element sealingly engage the exterior surface of the plunger.

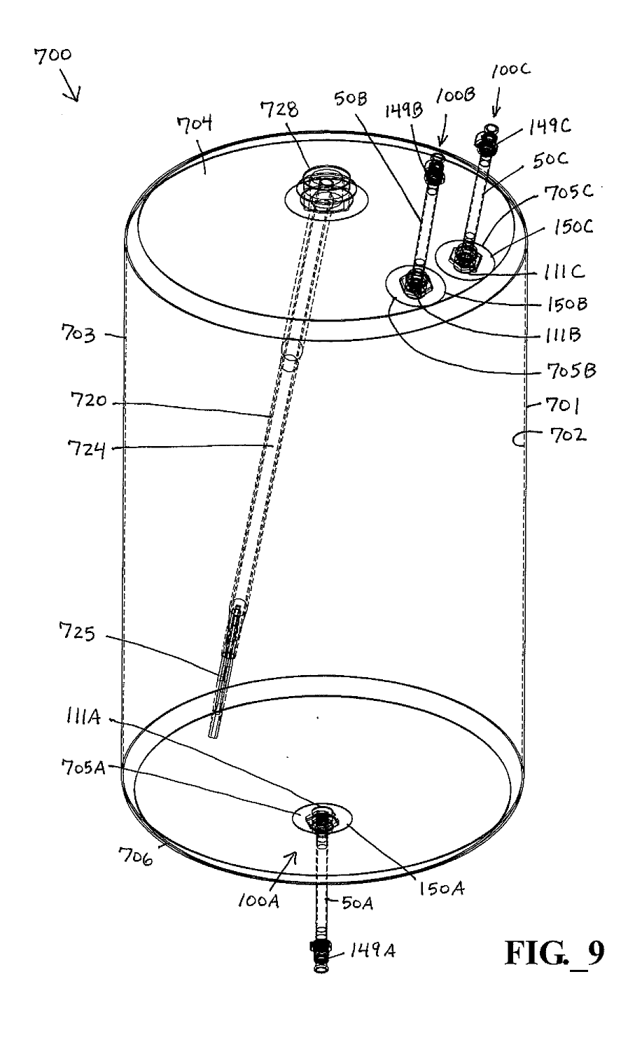

A tank or bag (referred to hereinafter as a tank 601 with the understanding that the tank 601 may refer to either a tank or bag) for use with a drain connector as described herein is illustrated in FIG. 8. The tank 601 includes a cavity-defining sealed sleeve 620 joined to (e.g., the top 604 of) the tank 601 and protruding into the tank 601. The cavity 623 contains a mixing paddle 625 and support rod 624. The function of the sleeve 620 is to serve as an isolation barrier between the mixing elements 624, 625 and the interior of the tank 601. If desired, the sleeve 620 may be fabricated from a polymer film with a lower seam 621 provided after the mixing elements 624, 625 are inserted into the sleeve 620, such that any of the mixing elements 624, 625 may be permanently retained by the sleeve 620. The sleeve 620 may include a reinforced aperture-defining coupling guide 628 to permit the support rod 625 to be inserted into the sleeve 620 and/or permit an external mixing mechanism (not shown) to be coupled to the support rod 625 while resisting puncture or damage of the sleeve 620. In operation, the paddle 625 and rod 624 contained within the sleeve 625 are preferably directed in a circular, oval, or other appropriate path within the tank 601 to stir or mix substances contained therein.

An upper seam 622 preferably joins the sleeve 620 to the upper wall 604 of the tank 601, with the sleeve 620 preferably permanently joined to the tank 601. Both the tank 601 and sleeve 620 preferably comprise polymeric materials suitable for economical single use (i.e., disposable) operation. In one embodiment, each of the tank 601 and sleeve 620 comprises a polymeric film; in a particularly preferred embodiment, each of the tank 601 and sleeve 620 comprises a substantially optically transmissive or transparent film. If desired, a substantially open external frame (not shown) may be provided to support the tank 601 with associated hooks or connectors (not shown). The upper wall of the tank further defines apertures 631, 632 serving as access ports for the admission of substances into the tank 601. Each aperture or port 631, 632 preferably has an associated supply line 633, 634, sealing element 635, 636, and coupling element 637, 638. The lower wall 606 of the tank 601 defines an aperture 605 adapted to receive a drain connector flange (such as any of the flanges 150, 250 described herein), which may be joined to the tank 601 by any appropriate means. The combination of the tank 601 and flange 150, 250 may be called a processing receptacle 600, similar to the receptacles 300, 400, 500, 500A shown in FIGS. 7A-7D.

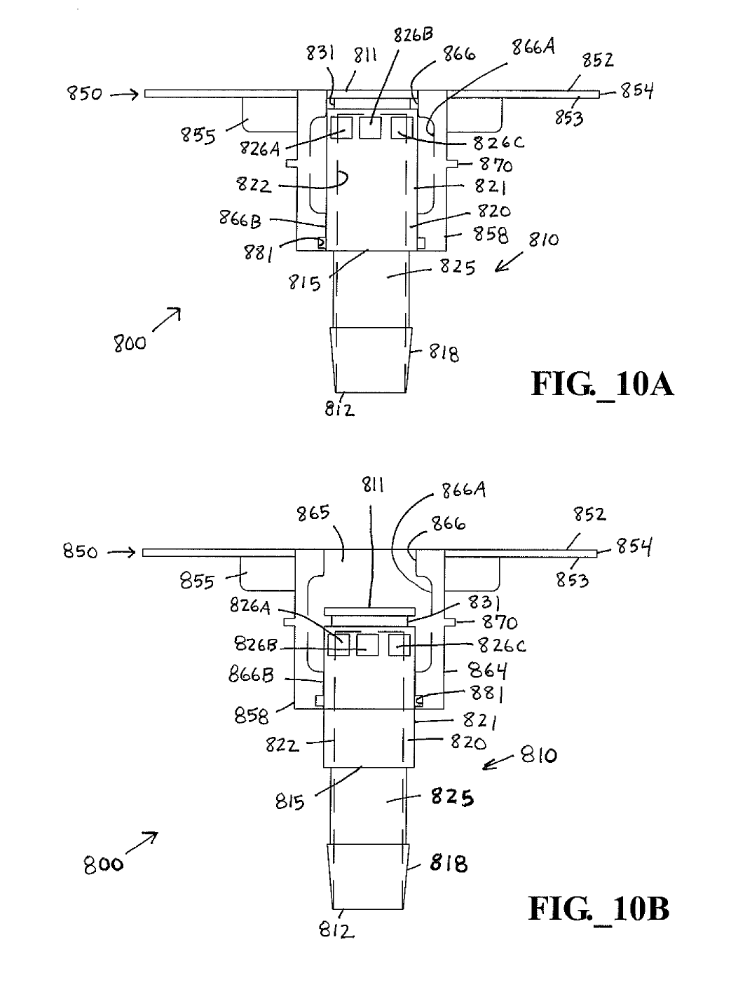

Another tank or bag (referred to hereinafter as a tank 701 with the understanding that the tank 701 may refer to either a tank or bag) to which three drain connectors 100A, 100B, 100C (preferably identical or substantially similar to the drain connector 100 as provided herein) are coupled is illustrated in FIG. 9. The tank 701 has an upper surface 704, a lower surface 706, an outer wall 703 and an inner wall 702. The tank 701 further includes a cavity defining sealed sleeve 720 joined to the top 704 of the tank 701 and protruding into the tank 701. The sleeve contains a mixing paddle 725 and support rod 724. The function of the sleeve 720 is to serve as an isolation barrier between the mixing elements 724, 725 and the interior of the tank 701. The paddle 725 and rod 724 contained within the sleeve 725 are preferably directed in a circular, oval, or other appropriate path within the tank 601 to stir or mix substances contained therein. A coupling guide 728 is preferably provided to permit the support rod 724 to be inserted into the sleeve 720 without damaging the sleeve 720. One or more external mixing mechanisms or elements (not shown) is preferably provided and coupled from above to cause the mixing rod 724 and paddle 725 to move within the tank 701.

The tank 701 defines three apertures or ports 705A-705C each having an associated drain connector 100A-100C. Each drain connector 100A-100C has a flange 150A-150C and plunger (with the sealed end 111A-111C of each plunger labeled in FIG. 9), an associated inlet/outlet tube 50A-50C, and a coupling 149A-149C associated with the inlet/outlet tube 50A-50C. The combination of the tank 701, sleeve 720 and contents 724, 725, and drain connectors 100A-100C may be termed a processing receptacle 700. In operation of the receptacle 700, substances are supplied to the tank 701 through, e.g., the upper drain connectors 100B, 100C, which may be opened for as long or short a period as desired and/or intermittently operated if desired. Substances are then processed within the tank 701. Following any processing steps, a drain connector, e.g., the lower drain connector 100A, may be opened to permit processed substances to exit the tank 701.

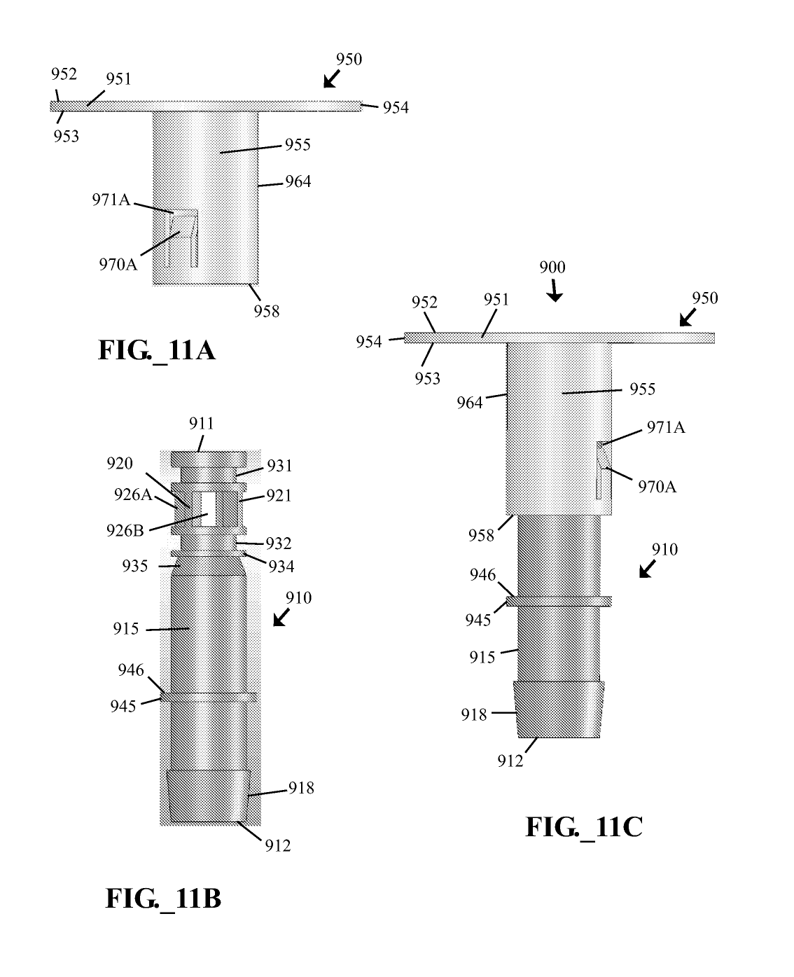

A drain connector 800 according to another embodiment is shown in FIGS. 10A-10B. Rather than being actuated by pressing a plunger outward from a flange in the direction of the associated tank or bank, this drain connector 800 is actuated by withdrawing the plunger 810 into the flange 850 in the direction away from the associated tank or bag (not shown). FIG. 10A shows the connector 800 in a closed state, while FIG. 10B shows the connector 800 in an open state. The hollow plunger 810 has a body 815, a first closed end 811, a second open end 812, and a wall 820 with an exterior surface 821 and an interior surface 822 defining a hollow core 825 leading to or open to the open end 812. Multiple passages 826A-826C are defined through the wall 820 and extend from the exterior surface 821 into the hollow core 825. The exterior surface 821 of the wall 820 further defines a circumferential recess 831 adjacent to the passages 826A-826C, with the recess 831 preferably being sized and shaped to retain an O-ring or equivalent sealing element. (For the sake of simplicity, sealing elements, which would fit into the recess 831 defined in the plunger 810, and into the recess 881 defined in the flange 850, have been omitted from FIGS. 10A-10B, but it is to be understood that sealing elements are preferably provided.) At the opposite end of the plunger 810, the plunger body 815 preferably includes a tapered neck portion 818 intended to mate with an outlet tube.

The flange 850 includes a flange lip 851 having an upper surface 852, a lower surface 853, and a peripheral edge 854. The flange lip 851 extends outward from the flange body 855. The flange body 855 defines an aperture 865 having a first portion bounded by an inner sealing surface 866 and a second, enlarged portion bounded by an inner recess surface 866A. The first portion bounded by the inner sealing surface 866 preferably has substantially constant interior dimensions to permit the plunger 810 to slide freely therein, with the O-ring (not shown) retained in the circumferential recess 831 contacting the inner surface 866. The flange body 855 includes an outer surface 864 with a retaining lip 870 protruding therefrom. The flange body 855 further includes a lower body surface 858 that is preferably annular in shape surrounding the aperture 865.

When the drain connector 800 is in the closed state (shown in FIG. 10A), sealing engagement between the sealing elements (not shown) fitted into the circumferential recess 831 and the inner sealing surface 866 prevents the passage of any substances from the tank (not shown) into the hollow core 825. When the drain connector 800 is in the open state (as shown in FIG. 10B), substances (e.g., contents of a tank) are permitted to flow into the recess 865 and through the passages 826A-826C into the hollow core 825 to exit the drain connector 800. Leakage between the flange 850 and plunger 810 is prevented by sealing engagement between a sealing element (not shown) fitted or otherwise provided in the recess 881 defined along a lower inner surface portion 866B of the flange. Thus, drain 800 connector includes two circumferential seals between the plunger 810 and the flange 850, with the passages 826A-826C leading to the hollow core 825 being disposed between the seals.

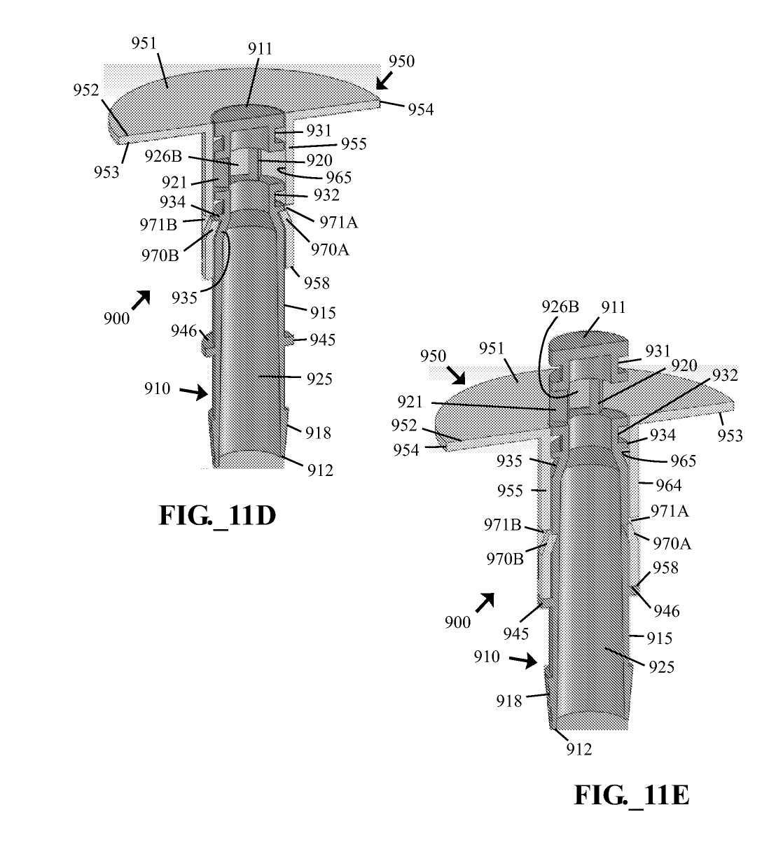

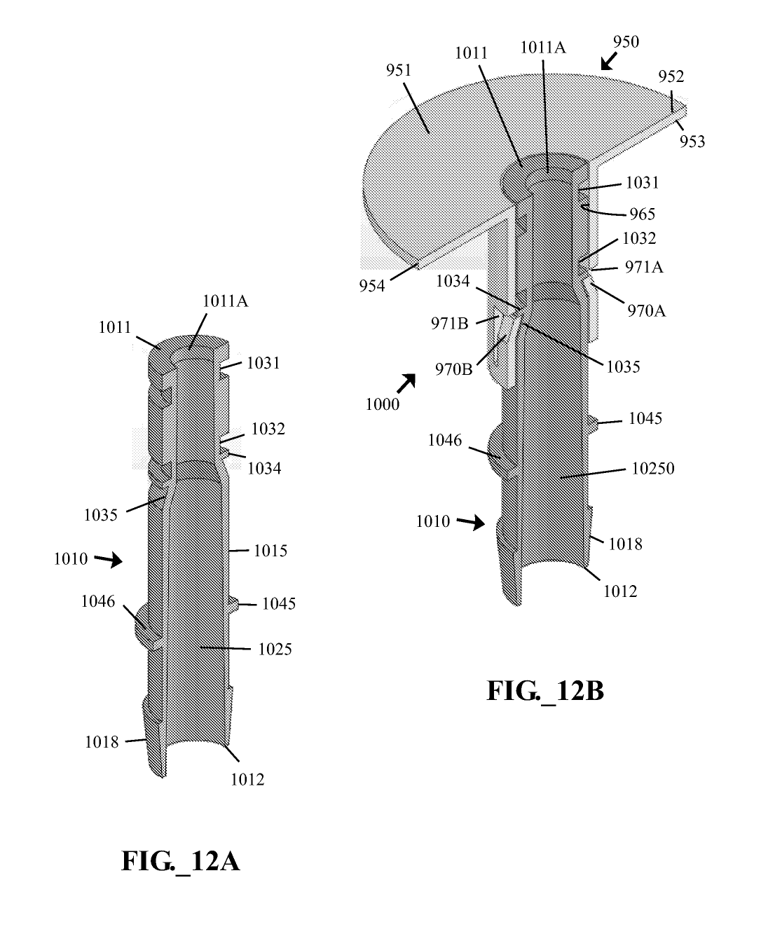

A drain connector 900 (including drain flange 950 and plunger 910 thereof) according to another embodiment is shown in FIGS. 11A-11E. A drain flange 950 includes a radially extending flange lip 951 having a first (e.g., upper) surface 952, an opposing second (e.g., lower) surface 953, and a peripheral edge 954. The flange lip 951 extends outward from a flange body 955 having an outer surface 964. The flange body 955 is generally annular in shape and defines an internal aperture or bore 965 dimensioned to receive a body portion 915 of a hollow plunger 910 (or alternatively, to receive a body 1015 of a hollow port 1010 illustrated in FIG. 12). Preferably, at least an upper portion (e.g., above the optional travel stop 945) of the body 915 of the hollow plunger 910 has a maximum outer diameter (i.e., region of greatest lateral extent that is no larger than the inner diameter (i.e., lateral extent) of the bore of the drain flange 950, such as may be useful to permit insertion and (e.g., vertical) movement of the hollow plunger 910 within the bore of the drain flange 950. The flange body 955 has an outer surface 964 and a lower edge 958. Disposed between the radially extending flange lip 951 and the lower edge 958 are retaining elements in the form of apertures 971A, 971B (defined in the flange body 955) and protrusions or tabs 970A, 970B. Preferably, the protrusions or tabs 970A, 970B are adapted (e.g., shaped and positioned) to exert a biasing force against a portion of the hollow plunger 910 (or alternatively against a portion of a hollow port 980 such as illustrated in FIG. 12) to maintain the hollow body in a selected position. A hollow plunger or hollow port may be described as a hollow body. The protrusions or tabs 970A, 970B may also serve to limit or at least inhibit downward travel of the plunger 935 when the plunger 935 is in a closed state relative to the flange 950, such as by contact between the protrusions or tabs 970A, 970B and a lip 934 that defines a lower boundary of a lower circumferential recess 932 arranged to receive an O-ring (not shown). The plunger 935 may include a tapered shoulder portion 935 arranged to contact the biasing tabs 970A, 970B when the plunger 910 is a closed state or position relative to the drain flange 950, such as illustrated in FIGS. 11C-11D. With respect to the biasing tabs 970A, 970B and apertures 971A, 971B, it is noted that retaining elements of other shapes and conformations may be substituted or additionally employed.

The hollow plunger 910 shown in FIGS. 11B-11E has a body 915 with a hollow (open) core 925, a closed first end 911, and an open second end 912. The closed first end 911 is preferably proximate to the radially extending flange lip 951 (e.g., when the plunger 910 is in a closed position) and the open second end 912 is distal from the flange lip 951. Multiple passages 926A-926C are defined through the body 915 and extend from an exterior (lateral) surface of the plunger 910 to the hollow core 925. Two circumferential recesses 931, 932 sized to retain O-rings or similar sealing elements (not shown) are adjacent to the passages 926A-926C, with the passages 926A-926C disposed between the recesses 931, 932, to provide sealing utility between the hollow plunger 910 and an inner surface of the bore 965 of the flange 950. As mentioned previously, the plunger 910 includes a tapered shoulder 935 disposed below the circumferential recesses 931, 932 and the lip 934, with the shoulder 935 being arranged to contact tabs 970A, 970B when the plunger 910 is in a closed state or position relative to the flange body 950 (as illustrated in FIGS. 11C-11D).

A flared and preferably tapered neck 918 is preferably provided proximate to the lower (open) end 912 of the plunger body 915, to mate with an outlet tube or conduit (not shown) to convey substances (e.g., fluids) through the hollow core 925 to or from the drain connector 900 and the interior volume of any processing container or bag (not shown) having a wall (e.g., bottom wall) to which the drain connector 900 is affixed or otherwise mounted. Such an outlet tube may be used to actuate the drain connector 900, such as to effectuate relative movement of the plunger 910 and the drain flange 950 from a closed position (shown in FIGS. 11C-11D) to an open position (shown in FIG. 11E), or vice-versa. Actuating means or elements other than an outlet tube or conduit may be employed, and subject to manual or automated actuation. When the drain connector assembly 900 (e.g., the plunger 910) is in an open state or position, at least an upper portion of the plunger (e.g., including upper surface 911) is preferably arranged to travel into an interior volume of a processing or container or bag (not shown) to which the drain flange 950 is mounted. The plunger 910 further includes a lower travel stop 945 that limits upward travel of the plunger 910, so that the plunger 910 cannot be pushed too far into a processing container or bag (not shown) to which the drain flange 950 is preferably mounted. An upper surface of the travel stop 945 is arranged to contact the lower edge 958 of the flange body 955 when the plunger 910 is in an open position or state, as shown in FIG. 11E. When the hollow plunger 910 is in a closed state, the closed end 911 is preferably disposed substantially flush with an upper surface 952 of the radially extending flange lip 951.

As shown in FIGS. 12A-12B, a hollow port 1010 may be utilized in conjunction with the drain flange 950, instead of utilizing a plunger 910. The hollow port 1010 includes a body portion 1015, with a first open end 1011 (defining an opening 1011A) and a second open end 1012 each in fluid communication with a hollow (open) core 1025 to permit the passage of fluids or other substances. An optional lower travel stop 1045 having an upper surface 1046 may extend outward from the body portion 1015, such as to prevent an upper end 1011 of the hollow port 1010 from being inadvertently thrust too far past the flange lip 951. An upper portion of the port body 1015 (e.g., above the lower travel stop 1045) is sized and shaped to permit insertion into the bore 965 of the drain flange 950. Below the first open end 1011 are arranged circumferential recesses 1031, 1032 that are sized to retain O-rings or similar sealing elements (not shown), to provide sealing utility between the hollow port 1010 and an inner surface of the bore 965 of the flange 950. A lip 1034 bounding the lower circumferential recess 1032 is disposed above a tapered shoulder 1035. When the hollow port 1010 is mated with the drain flange 950 (e.g., with the upper end 1011 of the port 1010 preferably disposed substantially flush with the radially extending flange lip 951), the port lip 1034 disposed above the tapered shoulder 1035 preferably contacts the biasing tabs 970A, 970B, to limit or at least inhibit downward movement of the port 1010 relative to the flange. A flared and preferably tapered neck 1018 is preferably provided proximate to one end 1012 of the port 1010, to mate with an outlet tube or conduit (not shown) to convey substances (e.g., fluids) through the hollow core 1025 to or from the hollow port 1010, the bore 965 of the drain flange 950, and the interior volume of any processing container or bag (not shown) to which the drain flange 950 is mounted.

The drain flange 950 illustrated in FIG. 11A and FIGS. 11C-11E is therefore generic for use with either a hollow plunger 910 or a hollow port 1010, such that a hollow plunger 910 and a hollow port 1010 may be used interchangeably and/or exchanged for the other. This enhances flexibility of manufacturing and using processing containers or processing bags, since the manufacturer or user can provide drain connectors with plunger-type valve utility or port utility at any of various flanges provided at different locations along a container or bag.

In one embodiment, multiple hollow plungers 910 and/or hollow ports 1010 may be provided with equally sized and shaped portions for mating with a unitary drain flange 950, but other portions of the hollow plungers and/or hollow ports may differ in at least one of core size, connection type, connection size, hollow body material type, circumferential sealing material type, and/or other characteristics, to provide desired connection utility, flow utility, sealing utility, and/or compatibility with processed materials. A processing container or processing bag may be manufactured with one or more drain flanges (as described herein) affixed or otherwise mounted thereto, and thereafter hollow plungers and/or hollow ports of compatible type (e.g., exterior dimensions along at least an portion insertable into a drain flange) but varying characteristics may be mated with such drain flanges. Multiple hollow plungers and/or hollow ports of compatible type but varying characteristics may be available for selection by a user or mechanized apparatus during manufacture of a container or bag having one or more drain flanges. This enables reduction in lead time for manufacturing customized processing containers or processing bags, and also minimizes need to maintain inventories of entire drain connectors of multiple types, since hollow plungers and/or hollow ports need not be specific to, or integrally assembled with, individual drain flanges. In one embodiment, a hollow plunger and/or a hollow port having a large core size may be selected to provide rapid draining utility. Alternatively, hollow bodies with smaller core size may be selected to facilitate periodic extraction of small sample volumes.

In one embodiment, a single drain flange may include multiple bores for receiving multiple hollow plungers or hollow ports of compatible type. The multiple bores may be equal or unequal in size. Bores may be arranged in any desirable geometric configuration relative to one another, such as in linear, triangular, rectangular, circular, or other polygonal arrangement. One advantage of providing multiple bores is to enable sequential, high integrity sampling of contents of a processing container or bag to which the drain flange is connected, since sterility or integrity of one sample can be assured the first time a previously closed extraction path (e.g., including a hollow plunger) is opened. Another advantage of providing multiple bores is to enable selective flow (e.g., utilizing hollow plungers or hollow ports of different sizes) for precise dispensing operations.

In one embodiment, a processing bag or container may be fabricated according to method steps including affixing at least one drain flange (e.g., via radio frequency or ultrasonic welding) to the bag or container, and thereafter inserting a hollow plunger or hollow port into the at least one drain flange. In one embodiment, a drain flange is affixed to an exterior surface of a processing bag or container. In another embodiment, a drain flange is affixed to an interior surface of a processing bag or container. Insertion of a hollow plunger or hollow port may be desirably accomplished from outside of the bag or container in a direction toward an interior volume of the bag or container (e.g., utilizing a plunger or port having at least an upper portion with a maximum diameter that is smaller than the diameter of a bore of a drain flange, as illustrated in FIGS. 10A-10B, 11B-11E, or 12A-12B), or alternatively from inside the bar or container, in a direction toward the outside of the bag or container. Insertion of a plunger or port into the bore of a drain flange from outside a processing container or bag is desirable to minimize contamination of the interior of the container or bag. The bag or container and the drain flange(s) may comprise polymeric materials (e.g., polymeric film). The bag or container is preferably sterilized after the drain flange(s) is/are affixed thereto Hollow plungers or hollow ports may be sterilized separately from the bag or container (and optionally packaged, stored, and unpackaged), prior to insertion into the drain flange(s). Alternatively, hollow plungers or hollow ports may be sterilized together with a processing bag or container and drain flange(s) after insertion of such plungers or ports into drain flange(s) thereof. The processing bag or container may be packaged to maintain sterile and/or contaminant-free conditions. Insertion of a hollow plunger or port into a drain flange may be accomplished in a clean room or comparable ultra-clean environment to minimize introduction of contaminants into a processing bag or container. The combination of a processing bag or processing container, one or more drain flanges, and one or more hollow bodies may be packaged together in a package adapted to maintain sterile and/or substantially contaminant-free conditions within the package.

Processing receptacles including drain connectors coupled to processing tanks and/or bags all as described herein may be put to various desirable uses. In one embodiment, such a processing receptacle may be used to mix and/or react industrial chemicals. In a first method step, at least one material is to a processing receptacle as described herein. In a second method step, the at least one material is processed within the receptacle. In a third method step, the at least one processed material is drained from the receptacle through a drain connector as described herein. In an optional method step, one or more materials may be supplied to the receptacle through the drain connector prior to the draining step. Such a step may include the supply of a gas such as oxygen or air to assist in aerating or facilitating a chemical reaction of materials disposed within the receptacle.

In another embodiment, a processing receptacle as described herein may be used to assist in pharmaceutical development, formulation, or manufacture. In a first method step, at least one material selected from: drug precursor materials, therapeutic agents, binding materials, bulk materials, coloring agents, flavoring agents, stabilizing agents, preservatives, and reagents is added to a processing receptacle. In a second method step, the at least one material is processed (e.g., mixed and/or reacted) within the receptacle. In a third method step, the at least one processed material is drained from the receptacle through a drain connector as described herein. In an optional method step, one or more materials (e.g., including gases) may be supplied to the receptacle through the drain connector prior to the draining step.

In another embodiment, a processing receptacle as described herein may be used to process biological materials. In a first method step, at least one of various biological materials is added to a processing receptacle. Non-biological materials may also be added if desired for a particular application. In a second method step, the at least one biological material is processed (e.g., mixed, reacted, and/or fermented) within the receptacle. In a third method step, the at least one processed material is drained from the receptacle through a drain connector as described herein. In an optional method step, one or more materials (e.g., including gases) may be supplied to the receptacle through the drain connector prior to the draining step.

In another embodiment, a processing receptacle as described herein may be used to process semiconductor precursor and/or processing materials. For example, wet solutions may be combined with abrasive materials to yield chemical mechanical polishing or planarization (CMP) slurries. In a first method step, at least one semiconductor precursor and/or processing material is added to a processing receptacle. In a second method step, the at least one semiconductor precursor and/or processing material is processed within the receptacle. In a third method step, the at least one processed material is drained from the receptacle through a drain connector as described herein. In an optional method step, one or more materials (e.g., including gases) may be supplied to the receptacle through the drain connector prior to the draining step.

While the invention has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Any one or more features as described herein are contemplated to be combined with one or more other features as described herein unless indicated to the contrary. Correspondingly, the invention as hereinafter claimed is intended to be broadly construed and interpreted, as including all such variations, modifications and alternative embodiments, within its spirit and scope.

1-14. (canceled)

15. A method of fabricating a processing container or processing bag defining an interior volume, the method comprising:
mounting at least one drain flange to at least one wall of the processing container or processing bag, the at least one drain flange comprising a radially extending flange lip and defining a bore having an inner diameter;
selecting at least one hollow body from a plurality of hollow bodies compatible with the at least one drain flange, the at least one hollow body having at least one end with a maximum outer diameter that is no larger than the inner diameter of the bore, and being arranged to convey fluid to or from the interior volume, wherein the plurality of hollow bodies comprises hollow bodies that differ with respect to at least one of core size, connection type, connection size, hollow body material type, circumferential sealing material type, and presence or absence of an end opening; and
inserting the selected at least one hollow body into the bore of the at least one drain flange.

16. The method of claim 15, wherein the selected at least one hollow body is inserted into the bore of the at least one drain flange from outside of the processing container or processing bag in a direction toward an interior volume of the processing container or processing bag.

17. The method of claim 15, wherein the plurality of hollow bodies comprises at least one hollow plunger and at least one hollow port.

18. The method of any claim 15, further comprising:
sterilizing the processing container or processing bag, the at least one drain flange, and the at least one selected hollow body, and
packaging the processing container or processing bag, the at least one drain flange, and the at least one selected hollow body in a package adapted to maintain sterile and/or substantially contaminant-free conditions within the package.

19-22. (canceled)

23. The method of claim 15, wherein the plurality of hollow bodies comprises hollow bodies that differ with respect to core size.

24. The method of claim 15, wherein the plurality of hollow bodies comprises hollow bodies that differ with respect to connection size

25. The method of claim 15 wherein the plurality of hollow bodies comprises hollow bodies that differ with respect to connection type.

26. The method of claim 15, wherein the plurality of hollow bodies comprises hollow bodies that differ with respect to hollow body material type.

27. The method of claim 15, wherein the plurality of hollow bodies comprises hollow bodies that differ with respect to circumferential sealing material type.

28. The method of claim 15, wherein the drain flange and the plurality of hollow bodies comprise at least one polymeric material.

29. The method of claim 16, further comprising:
sterilizing the processing container or processing bag, the at least one drain flange, and the at least one selected hollow body, and
packaging the processing container or processing bag, the at least one drain flange, and the at least one selected hollow body in a package adapted to maintain sterile and/or substantially contaminant-free conditions within the package.
